(19) United States
(12) Patent Application Publication
(10) Pub. No.: US 2026/0267859 A1
(43) Pub. Date: Sep. 10, 2026

(54) QUERY PROCESSING DEVICE AND METHOD

(71) Applicant: GraphAI Co., Ltd., Daejeon (KR)

(72) Inventors: Geon Ho LEE, Seoul (KR); Min Soo KIM, Seongnam-si (KR); In Ju NA, Daejeon (KR); Taek Yoon KIM, Anyang-si (KR)

(73) Assignee: GraphAI Co., Ltd., Daejeon (KR)

(21) Appl. No.: 19/414,443

(22) Filed: Dec. 10, 2025

(30) Foreign Application Priority Data
Mar. 10, 2025 (KR) 10-2025-0030803

(51) Int. Cl. G06F 16/2455; G06F 16/22; G06F 16/23; G06F 16/28

(52) U.S. Cl. CPC G06F 16/2456; G06F 16/2282; G06F 16/2365; G06F 16/284

(57) ABSTRACT

The present disclosure relates to a query processing device and method. The query processing device of the present disclosure includes a first storage device in which property information for vertices and edges is stored in relational tables, a second storage device in which a vertex record including connection information of the vertices in a graph and an edge record including connection information of edges in the graph are stored, and at least one processor for receiving a query for a property graph stored separately in the first storage device and the second storage device, calling data required for execution of the query, performing an operation on the query using a single integrated operator that performs at least one of traversal, join, and mapping operations depending on data types of a first operand and a second operand, and outputting a result of executing the query.

### CROSS-REFERENCE TO RELATED APPLICATION

This application claims priority to and the benefit of Korean Patent Application No. 10-2025-0030803, filed on Mar. 10, 2025, the disclosure of which is incorporated herein by reference in its entirety.

### BACKGROUND

### 1. Field of the Invention

The present disclosure relates to a query processing device and method, and more particularly, to a query processing device and method capable of processing relational database queries and graph queries.

### 2. Discussion of Related Art

With the advancement of technology and the spread of digital environments, vast amounts of data are being accumulated in various industries. In particular, in fields such as social network services, finance, e-commerce, biotechnology, and AI services, large amounts of data are continuously accumulated, and there is an increasing need for data analysis technologies to utilize the data effectively. In most industry fields, data is stored and managed in a structured format within a relational database (RDB). An RDB provides a table-based structured data storage scheme, and stores relationships between data and property information of the individual data in a tabular format. Accordingly, there is an increasing need for technologies that can effectively analyze data in an RDB.

In response to this need, graph analysis technologies have been developed to extract data in an RDB in the form of graphs and analyze the extracted graphs. With graph analysis technology, it is possible to effectively analyze complex inter-data connection relationships through graph traversal and perform analysis for complex patterns within data with high interconnectivity.

However, current graph analysis technologies have limitations in terms of a response time, throughput, and graph size in property graph processing. In particular, with current graph analysis technologies, it is difficult to execute queries for complex property graph patterns immediately when processing interactive queries that need to reflect user feedback immediately. For example, when provision of personalized trending feeds in an SNS, detection of fraudulent patterns in financial transactions, and provision of a user-customized product recommendation function in e-commerce are realized through interactive queries, the current graph analysis technologies have a problem that query processing performance is degraded as the number of join operations between RDB tables increases, and the graph size is limited by a memory capacity.

Therefore, there is a need for a technology for solving the above problems.

Meanwhile, the background technology described above is technical information that the inventor has possessed to derive the present disclosure or acquired in a process of deriving the present disclosure, and is not necessarily known art that was disclosed to the public before the filing of the present disclosure.

### PRIOR ART DOCUMENTS

### Patent Documents

(Patent Document 1) Korean Laid-Open Patent Publication No. 2008-0068035 (Jul. 22, 2008)

### SUMMARY OF THE INVENTION

An object of the present disclosure is to provide a query processing device and method capable of analyzing information desired by a user from a relational database in which a large amount of data is accumulated and graph data, and providing analysis results to the user.

Another object of the present disclosure is to provide a query processing device and method capable of effectively processing graph data and data of a relational database in an integrated manner so that a property graph can be effectively analyzed.

Still another object of the present disclosure is to provide a query processing device and method capable of rapidly processing interactive queries by processing relational database queries and graph queries in an integrated manner.

Still another object of the present disclosure is to provide a query processing device and method capable of improving query processing performance and processing large-scale graph data by storing a relational database and a graph topology in separate storage devices.

The objects of the present disclosure are not limited to the objects mentioned above, and other objectives that are not mentioned will be clearly understood by those skilled in the art from the following description.

As a technical means for achieving the above-described objects, according to an aspect of the present disclosure, a query processing device includes at least one memory including a plurality of instructions, a first storage device in which property information for vertices and edges is stored in relational tables, a second storage device in which a vertex record including connection information of the vertices in a graph and an edge record including connection information of edges in the graph are stored, and at least one processor electrically connected to the at least one memory and configured to execute the plurality of instructions, wherein, when the plurality of instructions are executed by the at least one processor, the at least one processor performs a plurality of operations, the plurality of operations include an operation of receiving a query for a property graph stored separately in the first storage device and the second storage device, an operation of calling data required for execution of the query from the first storage device and the second storage device, an operation of performing an operation on the query using a single integrated operator that performs at least one of traversal, join, and mapping operations depending on data types of a first operand and a second operand based on the called data, and an operation of outputting a result of executing the query, and the called data includes operands and operation relationship information between the operands defined by the query.

According to another aspect of the present disclosure, the vertex record may include an ID field, a label field, an output edge pointer field, an input edge pointer field, and a property-tuple pointer field, the edge record may include an ID field, a label field, a source vertex pointer field, a destination vertex pointer field, a next output edge pointer field, a next input edge pointer field, and a property-tuple pointer field, the output edge pointer field may store an address of at least one edge output from the vertex, the input edge pointer field may store an address of at least one edge input to the vertex, the property-tuple pointer field of the vertex record may store an address of the relational table connected to the vertex record, the next output edge pointer field may store an address of a next edge output from a source vertex stored in the source vertex pointer field, the next input edge pointer field may store an address of a next edge input to a destination vertex stored in the destination vertex pointer field, and the property-tuple pointer field of the edge record may store an address of the relational table connected to the edge record.

According to still another aspect of the present disclosure, the output edge pointer field may include one subfield for each label type of edges included in the graph, and the input edge pointer field may include one subfield for each label type of edges included in the graph.

According to still another aspect of the present disclosure, the plurality of operations may further include an operation of processing update requests corresponding to the first storage device and the second storage device in one transaction.

According to still another aspect of the present disclosure, the operation of processing the update requests in one transaction may include: an operation of receiving a label and a property of a graph element to be inserted into the first storage device and the second storage device, a first storage device update operation of storing the property of the graph element to be inserted in the relational table of the first storage device, and a second storage device update operation of storing the label of the graph element to be inserted into a label field of the vertex record or the edge record of the second storage device, and storing the address of the relational table in which the graph element to be inserted is stored in the property-tuple pointer field of the vertex record or edge record.

According to still another aspect of the present disclosure, the operation of processing the update requests in one transaction may include an operation of recording content of the update requests for the first storage device and the second storage device, and an operation of restoring all changes reflected in the first storage device and the second storage device to original states based on the recorded content of update requests when an error occurs in the update operation of the first storage device or the second storage device.

According to still another aspect of the present disclosure, the integrated operator may selectively perform traversal, join, and mapping operations within a single query processing layer.

According to still another aspect of the present disclosure, the operation of performing an operation on the query using the integrated operator may include an operation of performing a traversal operation on the first operand and the second operand when both the first operand and the second operand are graph elements including at least one of a set of vertices stored in the second storage device and a set of edges stored in the second storage device, an operation of performing a join operation on the first operand and the second operand when both the first operand and the second operand are relational data stored in the relational table of the first storage device, an operation of performing a first mapping operation between the graph element of the first operand and the relational database of the second operand when the first operand is the graph element and the second operand is the relational data, and an operation of performing a second mapping operation between the relational database of the first operand and the graph element of the second operand when the first operand is the relational database and the second operand is the graph element.

According to still another aspect of the present disclosure, the plurality of operations may further include an operation of generating a query processing plan based on the called data, the operation of generating the query processing plan may include an operation of calculating a cost for each possible operation order combination between the operands, and an operation of selecting an optimal subplan requiring the lowest cost in the possible operation order combinations, the operation of calculating the cost may include an operation of calculating a cost of the traversal operation using the integrated operator based on the number of traversal start points, disc I/O cost, CPU operation cost, and buffer cache effect, an operation of calculating a cost of the join operation using the integrated operator based on a size of a participating table, disc I/O cost, CPU operation cost, and intermediate result size, and an operation of calculating a cost of the mapping operation using the integrated operator based on a pointer traversal cost, disc I/O cost, and CPU operation cost, and the operation of calculating the cost of the traversal operation may include weighting disc access and operation costs by reflecting an average connection degree of the vertices when a traversal direction of the traversal operation proceeds from the vertex to the edge.

According to still another aspect of the present disclosure, the plurality of operations may further include an operation of extracting at least one graph from the relational table stored in the first storage device, and an operation of storing data of the extracted graph in the second storage device, the operation of calling the required data may include an operation of calling data related to the at least one graph from the second storage device, and the operation of performing an operation on the query may include an operation of performing an operation on data related to a plurality of graphs.

As a technical means for achieving the above-described objects, according to another aspect of the present disclosure, a query processing method is a method of processing a query in a query processing device including at least one memory including a plurality of instructions, a first storage device in which property information for vertices and edges is stored in relational tables, a second storage device in which a vertex record including connection information of the vertices in a graph and an edge record including connection information of edges in the graph are stored, and at least one processor electrically connected to the at least one memory and configured to execute the plurality of instructions, the method including: an operation of receiving a query for a property graph stored separately in the first storage device and the second storage device, an operation of calling data required for execution of the query from the first storage device and the second storage device, an operation of performing an operation on the query using a single integrated operator that performs at least one of traversal, join, and mapping operations depending on data types of a first operand and a second operand based on the called data, and an operation of outputting a result of executing the query, and the called data includes operands and operation relationship information between the operands defined by the query.

According to another aspect of the present disclosure, the vertex record may include an ID field, a label field, an output edge pointer field, an input edge pointer field, and a property-tuple pointer field, the edge record may include an ID field, a label field, a source vertex pointer field, a destination vertex pointer field, a next output edge pointer field, a next input edge pointer field, and a property-tuple pointer field, the output edge pointer field may include one subfield for each label type of edges included in the graph, and store an address of at least one edge output from the vertex, the input edge pointer field may include one subfield for each label type of edges included in the graph, and store an address of at least one edge input to the vertex, the property-tuple pointer field of the vertex record may store an address of the relational table connected to the vertex record, the next output edge pointer field may store an address of a next edge output from a source vertex stored in the source vertex pointer field, the next input edge pointer field may store an address of a next edge input to a destination vertex stored in the destination vertex pointer field, and the property-tuple pointer field of the edge record may store an address of the relational table connected to the edge record.

According to still another aspect of the present disclosure, the query processing method further may include an operation of processing update requests corresponding to the first storage device and the second storage device in one transaction.

According to still another aspect of the present disclosure, the operation of processing the update requests in one transaction may include an operation of receiving a label and a property of a graph element to be inserted into the first storage device and the second storage device, a first storage device update operation of storing the property of the graph element to be inserted in the relational table of the first storage device, and a second storage device update operation of storing the label of the graph element to be inserted into a label field of the vertex record or the edge record of the second storage device, and storing the address of the relational table in which the graph element to be inserted is stored in the property-tuple pointer field of the vertex record or edge record.

According to still another aspect of the present disclosure, the operation of processing the update requests in one transaction may include an operation of recording content of the update requests for the first storage device and the second storage device, and an operation of restoring all changes reflected in the first storage device and the second storage device to original states based on the recorded content of update requests when an error occurs in the update operation of the first storage device or the second storage device.

According to still another aspect of the present disclosure, the integrated operator may selectively perform the traversal, join, and mapping operations within a single query processing layer.

According to still another aspect of the present disclosure, the operation of performing an operation on the query using the integrated operator may include an operation of performing a traversal operation on the first operand and the second operand when both the first operand and the second operand are graph elements including at least one of a set of vertices stored in the second storage device and a set of edges stored in the second storage device, an operation of performing a join operation on the first operand and the second operand when both the first operand and the second operand are relational data stored in the relational table of the first storage device, an operation of performing a first mapping operation between the graph element of the first operand and the relational database of the second operand when the first operand is the graph element and the second operand is the relational data, and an operation of performing a second mapping operation between the relational database of the first operand and the graph element of the second operand when the first operand is the relational database and the second operand is the graph element.

According to still another aspect of the present disclosure, the query processing method may further include: an operation of generating a query processing plan based on the called data, wherein the operation of generating the query processing plan may include an operation of calculating a cost for each possible operation order combination between the operands, and an operation of selecting an optimal subplan requiring the lowest cost in the possible operation order combinations, the operation of calculating the cost may include an operation of calculating a cost of the traversal operation using the integrated operator based on the number of traversal start points, disc I/O cost, CPU operation cost, and buffer cache effect, an operation of calculating a cost of the join operation using the integrated operator based on a size of a participating table, disc I/O cost, CPU operation cost, and intermediate result size, and an operation of calculating a cost of the mapping operation using the integrated operator based on a pointer traversal cost, disc I/O cost, and CPU operation cost, and the operation of calculating the cost of the traversal operation may include weighting disc access and operation costs by reflecting an average connection degree of the vertices when a traversal direction of the traversal operation proceeds from the vertex to the edge.

According to still another aspect of the present disclosure, the query processing method may further include: an operation of extracting at least one graph from the relational table stored in the first storage device, and an operation of storing data of the extracted graph in the second storage device, the operation of calling the required data may include an operation of calling data related to the at least one graph from the second storage device, and the operation of performing an operation on the query may include an operation of performing an operation on data related to a plurality of graphs.

As a technical means for achieving the above-described objects, according to still another aspect of the present disclosure, a computer program may be stored on a computer-readable recording medium to execute the method according to any one of the above-described methods in conjunction with hardware.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a query processing device according to an embodiment of the present disclosure;

FIG. 2 is an illustrative diagram illustrating a layer in which a query processing operation is performed in the query processing device according to the embodiment of the present disclosure;

FIG. 3 is an illustrative diagram illustrating an operation of the query processing device according to the embodiment of the present disclosure;

FIG. 4 is an illustrative diagram illustrating a first storage device and a second storage device according to an embodiment of the present disclosure;

FIG. 5 is a table showing an integrated operator according to an embodiment of the present disclosure;

FIG. 6 is an illustrative diagram illustrating an operation of generating a query processing plan according to an embodiment of the present disclosure;

FIG. 7 is a sub-plan table showing an operation of generating a sub-plan by gradually increasing a size according to an embodiment of the present disclosure;

FIG. 8 is a table showing response time performance of the query processing device according to the embodiment of the present disclosure;

FIG. 9 is a table showing throughput performance of the query processing device according to the embodiment of the present disclosure; and

FIG. 10 is a flowchart illustrating a query processing method according to the embodiment of the present disclosure.

### DETAILED DESCRIPTION OF EXEMPLARY EMBODIMENTS

The advantages and features of the present disclosure and methods of achieving these will be clearly understood with reference to the embodiments described in detail below together with the accompanying drawings. However, the present disclosure is not limited to embodiments to be described below and may be implemented in various different forms, the present embodiments are provided merely to fully disclose the present disclosure and to fully inform those skilled in the art to which the present disclosure pertains of the scope of the invention, and the present disclosure is defined only by the claims.

The shapes, sizes, ratios, angles, numbers, and the like disclosed in the drawings for describing the embodiments of the present disclosure are illustrative, and the present disclosure is not limited to details shown in the drawings. In describing the present disclosure, when detailed description of known technologies is deemed to unnecessarily obscure the gist of the present disclosure, such description may be omitted. In the present disclosure, the terms “comprise,” “have,” and “configured of” may be used, and unless the term “only” is used, other parts may be added. When a component is expressed in the singular, the plural is also included unless explicitly stated otherwise.

Components are construed as include a margin of error unless otherwise explicitly stated.

Although “first,” “second,” and the like are used to describe various components, the components are not limited by the terms. The terms are used only to distinguish one component from another. Accordingly, a first component referred to below may also be a second component within the technical spirit of the present disclosure.

Unless otherwise specified, the same reference numerals refer to the same components throughout the specification.

The respective features of several embodiments of the present disclosure can be partially or entirely coupled or combined with each other, various types of technical linkages and driving are possible as will be readily understood by those skilled in the art, and the respective embodiments may be implemented independently or in association with others.

Hereinafter, terms used in the present disclosure will be defined.

In the present disclosure, the term “engine” may refer to a part of software executed by a processor, a part of a program unit, or a part of hardware. Further, in the present disclosure, the term “module” may refer to a single unit in which a part of hardware and a part of software constituting a program are combined.

Hereinafter, the present disclosure will be described in detail with reference to the accompanying drawings.

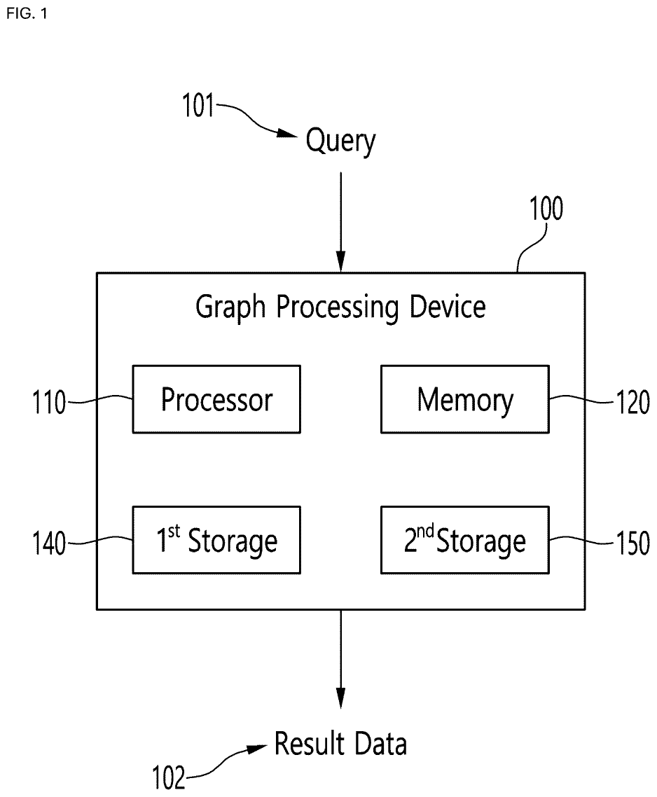

FIG. 1 is a block diagram illustrating a query processing device according to an embodiment of the present disclosure.

Referring to FIG. 1, a query processing device 100 includes a processor 110, a memory 120, a first storage device 140, and a second storage device 150.

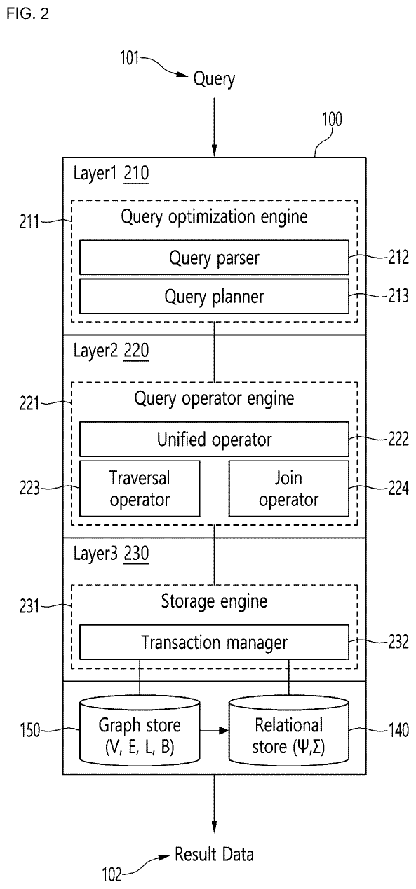

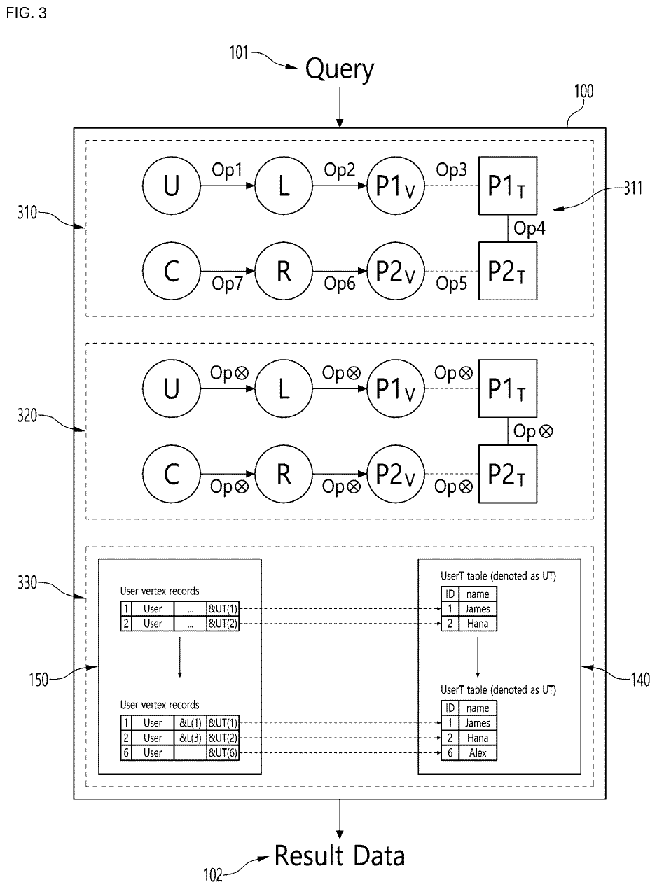

The query processing device 100 may be a device that processes a received query 101 based on a relational database and the graph data and outputs result data 102. Specifically, the query processing device 100 may perform a graph traversal operation and a property filtering operation based on the received query 101, and output result data 102 requested by the query 101. The query 101 and the result data 102 will be described in detail below with reference to FIGS. 2 and 3.

The query processing device 100 may be included in various electronic devices. For example, the query processing device 100 may be included in a personal computer (PC), a data server, or a portable device.

The at least one processor 110 may be a data processing device implemented as hardware including a circuit having a physical structure for executing a desired operation. The desired operation may include code or instructions included in a program. For example, the processor 110 implemented as hardware may include a microprocessor, a central processing unit (CPU), a processor core, a multi-core processor, a multiprocessor, an application-specific integrated circuit (ASIC), or a field programmable gate array (FPGA).

The at least one memory 120 may include a volatile memory device or a non-volatile memory device. For example, the at least one memory 120 may include at least one of a non-volatile memory device such as an electrically erasable programmable read-only memory (EEPROM), a flash memory, and a magnetic RAM (MRAM), or a volatile memory device such as a dynamic random access memory (DRAM), a static random access memory (SRAM), a thyristor RAM (T-RAM), a zero capacitor RAM (Z-RAM), or a twin transistor RAM (TTRAM).

The at least one memory 120 may store computer-readable code (for example, software) and a plurality of instructions. Further, the at least one memory 120 may include data required for a processing operation of the processor 110 or data generated in a query execution operation. According to various embodiments of the present disclosure, the at least one memory 120 may store the relational database and the graph data.

The processor 110 may be electrically connected to the memory 120 to process the data stored in the memory 120. Specifically, the processor 110 may execute computer-readable code and instructions stored in the memory 120. For example, the processor 110 can perform a series of operations from an operation of receiving the query 101 to an operation of outputting the result data 102, by executing the plurality of instructions stored in the memory 120. In other words, the operations performed within the query processing device 100 may be operations that the processor 110 substantially performs by executing the plurality of instructions stored in the memory 120. An operation performed by the engine is also ultimately included in the operation performed by the processor. For example, a query optimization engine, a query operation engine, and a storage engine of the query processing device 100 may be distinguished as independent engines, but may operate as parts of a software program executed by the processor rather than as separate hardware devices. Accordingly, the expression “operation performed by the engine” in the present disclosure substantially refers to an operation that is executed by the processor, which may be an operation that is included in a series of operations performed by the processor in the query processing device 100.

The first storage device 140 and the second storage device 150 may be various types of storage devices. Specifically, the first storage device 140 and the second storage device 150 may be disc-based storage devices. For example, the first storage device 140 and the second storage device 150 may be non-volatile mass storage devices including at least one of a hard disk drive (HDD) and a solid state drive (SSD). More specifically, the first storage device 140 and the second storage device 150 may be disc storage devices suitable for online transaction processing (OLTP). Examples of the first storage device 140 and the second storage device 150 include at least one of an NVMe SSD, a PCIe SSD, an SATA SSD, a RAID-configured SSD, and a storage array-based SSD.

The first storage device 140 and the second storage device 150 may store at least one of program code for controlling the query processing device 100 and settings, database table information, graph model information, query processing operator information, a cost model, and a query optimization plan. Specifically, the first storage device 140 may store data of the relational database, and the second storage device 150 may store graph data. For example, the first storage device 140 may store property information of vertices and edges in the form of relational tables, and the second storage device 150 may store a vertex record including connection information between vertices and an edge record including connection information between edges in a graph. The data stored in the first storage device 140 and the second storage device 150 will be described in detail below with reference to FIGS. 2 and 3.

FIG. 2 is an illustrative diagram illustrating a layer in which a query processing operation is performed in the query processing device according to the embodiment of the present disclosure. FIG. 3 is an illustrative diagram illustrating an operation of the query processing device according to the embodiment of the present disclosure.

Referring to FIGS. 2 and 3, the query processing device 100 may include three layers 210, 220, and 230 in which a series of operations 310, 320, and 330 of processing the query 101 are performed. Specifically, the query processing device 100 may perform the operation 310 for analyzing and optimizing the query 101 in the first layer 210, perform the operation 320 of processing the query 101 in the second layer 220, and perform the operation 330 for updating and synchronizing the storage devices in the third layer 230. The layer may be a logical layer which distinguishes operations of the query processing device 100 and in which a specific operation is performed.

Referring to FIGS. 2 and 3, the query 101 may include a query for a property graph stored separately in the first storage device 140 and the second storage device 150. Specifically, the query 101 may include a database query, a graph query, or a query in which the database query and the graph query are mixed. More specifically, the query 101 may include a composite query in which the database query and the graph query are mixed. For example, the query 101 may be an SQL-based graph query. That is, the query 101 may be an SQL with property graph queries (SQL/PGQ) query.

The query 101 may include query information regarding the graph to be analyzed. Specifically, the query 101 may be a query for requesting to search for a specific pattern in a property graph and return a subgraph that has been searched for or vertex and edge data constituting the subgraph by including query information regarding vertices, edges, and properties of a graph to be analyzed. More specifically, the query 101 may be a query for requesting to return a subgraph satisfying the query or vertex and edge data constituting the subgraph by including property data-related queries and graph topology-related queries with respect to the property graph stored in the query processing device 100. For example, the query 101 may include a query related to posts created around the same time as the post on which “like” is clicked by a user with User ID=1. In this case, the query 101 may be a query for requesting to search for a graph pattern having a connection relationship of a User vertex U—Likes edge L—Post vertices P1_{V} and P2_{V} and property information related to post creation time, and returning post vertices that satisfy the query.

Referring to FIGS. 2 and 3, the result data 102 may be data requested to be returned by the query 101. Specifically, the result data 102 may be a result obtained by the query processing device 100 analyzing the property graph according to the query 101. For example, when the query 101 is the query related to the posts created around the same time as the post on which “like” is clicked by a user with User ID=1, the result data 102 may be a subgraph that satisfies the query itself, a list of the posts created around the same time, the number of such posts, or creation times of the posts.

Referring to FIGS. 2 and 3, in the first layer 210, the query processing device 100 may perform the operation 310 of analyzing and optimizing the query 101. The operation 310 of analyzing and optimizing the query 101 in the query processing device 100 may include an operation of receiving the query 101, an operation of extracting a query operation structure 311 from the query 101, an operation of calling the data required for execution of the query 101, an operation of generating a query processing plan, or an operation of outputting the result data 102 according to the execution of the query 101. According to various embodiments of the present disclosure, the query processing device 100 may perform the operation of receiving the query 101, the operation of calling the data required for execution of the query 101, or the operation of outputting the result data 102 according to the execution, in a layer separate from the first layer 210. For example, the query processing device 100 may perform the operation of calling the data required for execution of the query 101 in the second layer 220.

The first layer 210 may include at least one query optimization engine 211. Specifically, the first layer 210 may include at least one query optimization engine 211 that includes a query parser 212 or a query planner 213. In some cases, the first layer 210 may include a query optimization engine 211 including the query parser 212 and a separate query optimization engine 211 including the query planner 213. In the present embodiment, an example in which the first layer 210 includes one query optimization engine 211 including both the query parser 212 and the query planner 213 will be described.

Referring to FIGS. 2 and 3, the query optimization engine 211 may perform the operation 310 of analyzing and optimizing the query 101. The operation 310 in which the query optimization engine 211 analyzes and optimizes the query 101 may include at least one of an operation of receiving the query 101, an operation of extracting the query operation structure 311 from the query 101, an operation of calling the data required for execution of the query 101, an operation of generating a query processing plan, and an operation of outputting the result data 102 according to the execution of the query 101. Specifically, the query optimization engine 211 may perform the operation of extracting the query operation structure 311 from the query 101 using the query parser 212.

The operation of extracting the query operation structure 311 may include an operation of interpreting the query 101 using the query parser 212 and generating an intermediate representation (IR) in the query optimization engine 211, and an operation of defining the query operation structure 311 based on the generated IR. For example, the query optimization engine 211 may extract a User vertex U, a Likes edge L, Post vertices P1_{V} and P2_{V}, Post tables P1_{T} and P2_{T}, a ReplyOf edge R, and a Comment vertex C from the query 101, and define an operation relationship among them. The IR may be a structured data format representing operands, operators, and operation relationships included in the query 101.

In some cases, the query optimization engine 211 may perform an operation of calling the data required for execution of the query 101 from the first storage device 140 and the second storage device 150. The operation of the query optimization engine 211 calling the data required for execution of the query 101 from the first storage device 140 and the second storage device 150 may include an operation of calling data related to the operands, operators, and operation relationships defined in the query operation structure 311 from the first storage device 140 and the second storage device 150. Specifically, the operation of the query optimization engine 211 calling the data required for execution of the query 101 from the first storage device 140 and the second storage device 150 may include an operation of calling data related to vertex records, edge records, and property tables defined in the query operation structure 311 from the first storage device 140 and the second storage device 150. For example, the query optimization engine 211 may call data related to the post tables P1_{T} and P2_{T} from the first storage device 140, and call data related to the User vertex U, Likes edge L, Post vertices P1_{V} and P2_{V}, ReplyOf edge R, and Comment vertex C from the second storage device 150. That is, the data required for execution of the query 101 may include operands and operation relationship information between the operands defined by the query 101. Specifically, the data required for execution of the query 101 may be a record for the vertex and edges, and a property table defined by the query operation structure 311. Accordingly, the query optimization engine 211 may call the vertex record, the edge record, and the property table defined by the query operation structure 311 from the relational database stored in the first storage device 140 and the graph data stored in the second storage device 150. Accordingly, the query processing device 100 may not call unnecessary data stored in the first storage device 140 and the second storage device 150, but not defined in the query operation structure 311.

A calling operation may be an operation of scanning data stored in the storage device. The calling operation may include an operation of identifying a specific data block in the first storage device 140 and the second storage device 150, and an operation of performing a disc I/O operation to read a page in which the data blocks are stored. In some cases, the calling operation may also include an operation of retrieving the data stored in the storage device and loading the retrieved data into a memory. Thus, the query processing device 100 executes the query 101 based on the data loaded into the memory, thereby preventing an I/O bottleneck and greatly improving a processing speed of the query 101.

The query processing device 100 according to the embodiment of the present disclosure may omit unnecessary disk I/O and shorten response time by calling only the data required for execution of the query 101 from the storage device. In addition, the query processing device 100 may save memory space by not loading data unnecessary for executing the query 101 into the memory. Accordingly, the query processing device 100 may perform the query 101 with sufficient memory even for large-scale graph data.

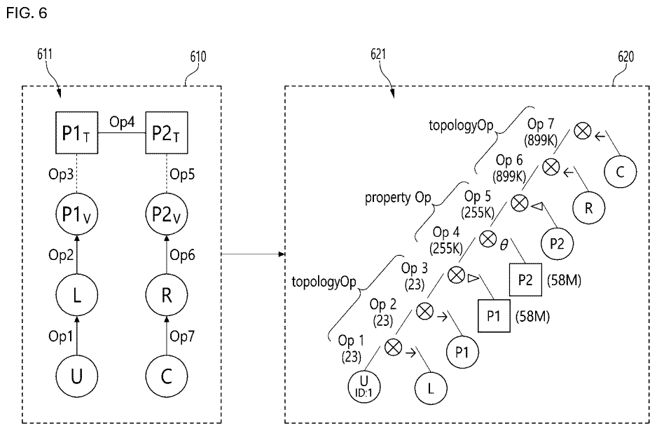

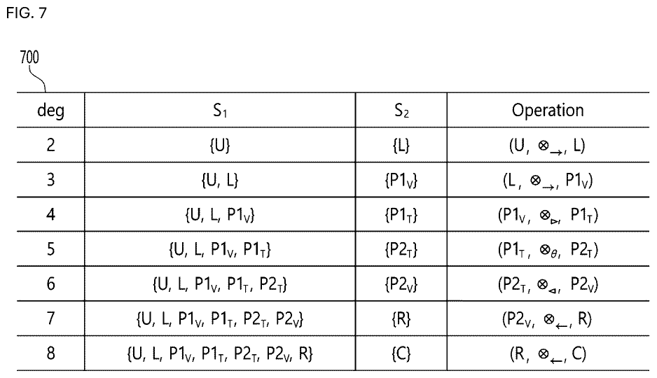

According to various embodiments, the query optimization engine 211 may perform an operation of generating a query processing plan for the query 101 using the query planner 213. Specifically, the query optimization engine 211 may perform an operation of generating at least one subplan for the query 101 and determining an optimal plan using the query planner 213. For example, the query optimization engine 211 may determine an operation order between operands defined by the query operation structure 311 based on a cost. Details regarding the operation of generating the query processing plan will be described below with reference to FIGS. 6 and 7.

Referring to FIGS. 2 and 3, in the second layer 220, the query processing device 100 may perform an operation 320 of executing the query 101. The operation 320 of executing the query 101 may include an operation of performing at least one of traversal, join, and mapping operations based on the data of the relational database and the graph data. Specifically, the operation 320 of executing the query 101 may include an operation of selectively performing the traversal, join, and mapping operations based on the called data. More specifically, the operation 320 of executing the query 101 may include an operation of performing the traversal, join, and mapping operations according to the data type of an operand based on the called data. In other words, the query processing device 100 may perform all of the traversal, join, and mapping operations on both the data of the relational database and the graph data on the single second layer 220.

The second layer 220 may include at least one query operation engine 221. Specifically, the second layer 220 may include at least one query operation engine 221 including an integrated operator 222. Preferably, the second layer 220 may include the single query operation engine 221 including the integrated operator 222. In some cases, the second layer 220 may include at least one query operation engine 221 having a traversal operator 223 or a join operator 224.

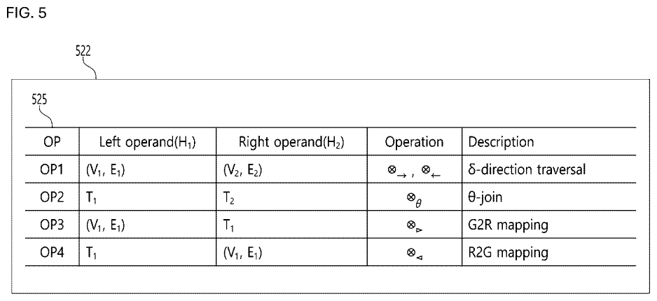

Referring to FIGS. 2 and 3, the query operation engine 221 may perform an operation 320 of executing the query 101 using the integrated operator 222. The operation 320 of executing the query 101 may include an operation in which the query operation engine 221 performs at least one of the traversal, join, and mapping operations according to a type of operand by using the single integrated operator 222. Specifically, the operation 320 of executing the query 101 may include an operation of performing at least one of the traversal, join, and mapping operations according to data types of the first operand and the second operand based on the called data using the single integrated operator 222. In other words, the integrated operator 222 may selectively perform all of the traversal, join, and mapping operations within the single query operation engine 221 and the single second layer 220. Details of the operation of the integrated operator 222 will be described below with reference to FIG. 5.

In some cases, the query operation engine 221 may perform the traversal operation using the traversal operator 223 or perform the join operation using the join operator 224. For example, when the query 101 includes only a traversal operation between vertices or edges, or includes only an operation between property tables, the query operation engine 221 may perform the traversal operation and the join operation using the traversal operator 223 and the join operator 224. In the present embodiment, an example in which the query operation engine 221 executes the query 101 using the single integrated operator 222 will be described.

The query processing device 100 according to the embodiment of the present disclosure may selectively perform all of the traversal, join, and mapping operations for the query 101 using the integrated operator 222, thereby performing the operations for the query 101 within a single layer. Thus, the query processing device 100 performs the traversal, join, and mapping operations for the query 101 within the single second layer 220, thereby minimizing unnecessary data movement between different layers. Accordingly, the query processing device 100 minimizes unnecessary data movement between the different layers, thereby preventing data transfer costs from occurring and improving query processing speed.

Further, the query processing device 100 according to the embodiment of the present disclosure can dynamically optimize an order of the traversal, join, and mapping operations by performing the traversal, join, and mapping operations for the query 101 within the single second layer 220. When the join operation and the traversal operation are performed in separate layers, there is a problem that the join operation or the traversal operation needs to be performed separately before the mapping operation is performed, or the mapping operation needs to be performed before the join operation or the traversal operation is performed in order to minimize occurrence of costs due to data movement between the layers or data movement between the engines. Accordingly, when the join operation and the traversal operation are performed in separate layers, additional costs may occur, or inefficiencies in query optimization may arise. On the other hand, the query processing device 100 according to the embodiment of the present disclosure dynamically optimizes the execution order of the traversal, join, and mapping operations within the single layer, thereby deriving the most optimized query processing plan.

Referring to FIGS. 2 and 3, in the third layer 230, the query processing device 100 may perform an operation 330 of updating and synchronizing the storage devices. The operation 330 of updating and synchronizing the storage devices may include an operation in which the query processing device 100 updates and synchronizes the storage devices on a transaction basis. Specifically, the operation 330 of updating and synchronizing the storage devices may include an operation in which the query processing device 100 processes update requests corresponding to the first storage device 140 and the second storage device 150 in one transaction.

The third layer 230 may include at least one storage engine 231. Specifically, the third layer 230 may include at least one storage engine 231 comprising a common transaction manager 232. More specifically, the third layer 230 may include a single storage engine 231 that updates and manages the first storage device 140 and the second storage device 150 using the common transaction manager 232.

Referring to FIGS. 2 and 3, the storage engine 231 may perform the operation 330 of updating and synchronizing the storage devices. The operation 330 of updating and synchronizing the storage devices may include an operation of updating the data of the first storage device 140 and the second storage device 150 on a transaction basis using the common transaction manager 232. Specifically, the operation 330 of updating and synchronizing the storage devices may include an operation in which the storage engine 231 processes update requests corresponding to the first storage device 140 and the second storage device 150 in one transaction using the common transaction manager 232. For example, the storage engine 231 may perform a data search, insertion, update, or deletion operation for the first storage device 140 and the second storage device 150 in one transaction using the common transaction manager 232. That is, the storage engine 231 may batch-process the update request for the first storage device 140 and the update request for the second storage device 150 in one transaction. In some cases, the storage engine 231 may process a plurality of update requests for the first storage device 140 and the second storage device 150 in parallel in a plurality of transactions. Even in this case, each of the plurality of transactions may include an update request for the first storage device 140 and an update request for the second storage device 150.

An operation of integrating update requests and processing the update requests in one transaction may include an operation of receiving labels and properties of graph elements to be inserted into the first storage device 140 and the second storage device 150 using the common transaction manager 232, a first storage device update operation of storing the properties of the graph elements to be inserted in the relational table of the first storage device 140, and a second storage device update operation of storing the labels of the graph elements to be inserted in the label field of the vertex record or the edge record of the second storage device 150 and storing an address of the relational table in which the graph elements to be inserted are stored in the property-tuple pointer field. For example, properties ID=6 and name=Alex may be inserted into a UserT table of the first storage device 140, and ID field=6, label field=User, and property-tuple pointer field=&UT(6) may be added to user vertex records of the second storage device 150.

In some cases, the operation of integrating update requests and processing the update requests in one transaction may include an operation of recording the content of the update request for each of the first storage device 140 and the second storage device 150, and an operation of restoring all changes reflected in the first storage device and the second storage device to original states based on the recorded content of the update request when an error occurs in an update operation of the first storage device 140 or the second storage device 150. For example, when an error occurs in a process of inserting properties ID=6 and name=Alex into the UserT table of the first storage device 140 and inserting ID field=6 into the user vertex records of the second storage device 150, properties ID=6 and name=Alex in the UserT table inserted into the first storage device 140 may be deleted.

The query processing device 100 according to the embodiment of the present disclosure performs the update and synchronization operations for the first storage device 140 and the second storage device 150 using the integrated transaction manager 232, thereby performing real-time synchronization between the storage devices and processing queries in a state in which the latest data is reflected.

In addition, the query processing device 100 according to the embodiment of the present disclosure batch-processes the update and synchronization operations for the first storage device 140 and the second storage device 150 using the single integrated transaction manager 232, thereby more effectively ensuring atomicity, consistency, isolation, and durability (ACID) properties between the first storage device 140 and the second storage device 150. When a separate transaction manager exists in each storage device, additional network and computation costs for coordinating transactions may occur and data synchronization may be delayed depending on an update cycle of each transaction manager. On the other hand, the query processing device 100 according to the embodiment of the present disclosure may perform the update and synchronization operations for the first storage device 140 and the second storage device 150 using the single integrated transaction manager 232, thereby reducing unnecessary delays and performing fast data insertion, modification, and deletion operations.

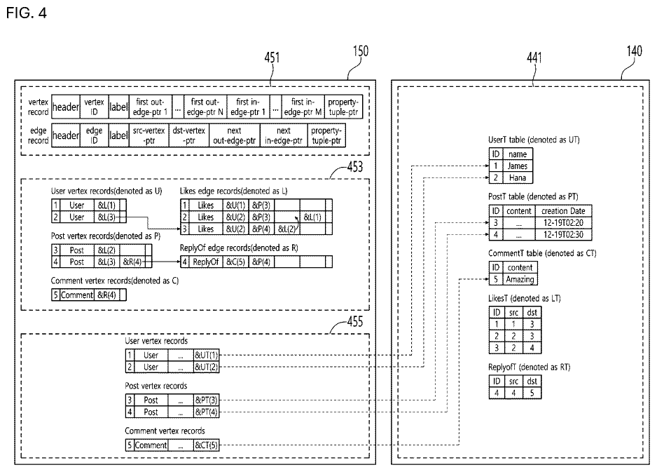

Referring to FIGS. 2 and 3, the first storage device 140 may be a relational storage device that stores the data of the relational database. Specifically, the first storage device 140 may store property data of each vertex and property data of each edge in the form of a relational table. For example, the first storage device 140 may store a set of tuples Ψ included in the vertex table and a set of tuples Σ stored in the edge table. A detailed storage format of the relational database stored in the first storage device 140 will be described below with reference to FIG. 4.

Referring to FIGS. 2 and 3, the second storage device 150 may be a graph storage device that stores a graph topology. Specifically, the second storage device 150 may store the graph topology in the form of a vertex record and an edge record. For example, the second storage device 150 may include information on a set of vertices V, a set of edges E, pointers L indicating connections between vertices or edges, and a pointer B indicating connections between vertices or edges and a property table. The graph topology may include information on a connection form and connection relationship between the vertices and the edges of the graph. A detailed storage format of the graph topology stored in the second storage device 150 will be described below with reference to FIG. 4.

The query processing device 100 according to the embodiment of the present disclosure stores the graph topology in a storage device separate from the relational database, thereby avoiding an addition operation of converting the graph query into the relational database query and preventing excessive increase in the join operation between tables. That is, the query processing device 100 directly executes the graph query using the graph data called from the second storage device 150, thereby omitting the addition operation of converting the graph query into the database query. Accordingly, the query processing device 100 executes the graph query without the addition operation of converting the graph query into the database query, thereby executing the composite query more efficiently.

Further, the query processing device 100 according to the embodiment of the present disclosure stores the graph topology in the second storage device 150 based on a disc, thereby increasing a size of an analyzable graph. When the graph data or the graph view is stored in a memory rather than on a disc-based medium, the size of analyzable graphs may be limited by a size of the memory. On the other hand, the query processing device 100 executes the graph query on the graph topology stored in the second storage device 150 based on a disc having a relatively large capacity, thereby executing the queries on a large-scale graph.

Further, the query processing device 100 according to the embodiment of the present disclosure stores the graph topology in the second storage device 150 based on a disc suitable for OLTP, thereby easily performing data insertion, update, and deletion operations. When the graph data is stored in a memory optimized for a read operation, the graph data is difficult to change and a delay may occur in reflecting the latest data. On the other hand, the storage engine 231 of the query processing device 100 according to the embodiment of the present disclosure updates the graph topology stored in the second storage device 150 in real time, thereby processing the queries based on a graph reflecting the latest data. Therefore, the query processing device 100 can rapidly and accurately process interactive queries based on the graph topology updated in real time.

Further, the query processing device 100 according to the embodiment of the present disclosure stores the property data of the relational database and the graph topology in the first storage device 140 and the second storage device 150 based on a disc suitable for OLTP, thereby efficiently synchronizing the property data of the relational database and the graph topology. When the property data is stored on a disc and the graph topology is stored in a memory, the ACID properties between the property data and the graph topology may not be guaranteed. On the other hand, the query processing device 100 according to the embodiment of the present disclosure simultaneously updates the first storage device 140 and the second storage device 150 based on a disc suitable for OLTP on a transaction basis, thereby more effectively guaranteeing the ACID properties of the property data of the relational database and the graph topology.

Moreover, the query processing device 100 according to the embodiment of the present disclosure stores the graph topology and the data of the relational database in separate storage devices, thereby utilizing both the graph topology and the data of the relational database as first-class citizens of equal importance. Accordingly, the query processing device 100 processes both the graph topology and the data of the relational database as the first-class citizens, thereby efficiently optimizing the composite query. When the optimization of the graph queries and the optimization of the relational database queries are executed separately, additional cost and delay may occur in a step of binding the optimized graph queries and the optimized relational queries. On the other hand, the query processing device 100 according to the embodiment of the present disclosure optimizes both the relational database queries and the graph queries included in the composite query in a single layer instead of separately optimizing the queries, thereby executing the composite query using the most optimized plan.

According to various embodiments of the present disclosure, the query processing device 100 may further include an operation of extracting at least one graph from the relational database stored in the first storage device 140 and storing data of the extracted graph in the second storage device 150. Specifically, the query processing device 100 may extract a plurality of graphs from the relational database stored in the first storage device 140 and store the plurality of extracted graphs in the second storage device 150. For example, the query processing device 100 may extract a first graph and a second graph from the relational database stored in the first storage device 140 and store data of the extracted first and second graphs in the second storage device 150.

The query processing device 100 may call data of any one of the plurality of graphs in the second storage device 150 according to a name of the graph included in the query 101. The called data may be the data required for execution of the query 101. In some cases, the query processing device 100 may simultaneously call data for the plurality of graphs stored in the second storage device 150 and process the query 101 based on the called data. For example, the query processing device 100 may call the data of both the first graph and the second graph from the second storage device 150 and process the query 101 based on the data of both. That is, the operation in which the query processing device 100 and the query optimization engine 211 call the data required for execution of the query 101 may include an operation of calling data related to at least one graph from the second storage device 150. Specifically, the operation in which the query processing device 100 and the query optimization engine 211 call the data required for execution of the query 101 may include an operation of selectively calling data related to one of the plurality of graphs from the second storage device 150 and an operation of simultaneously calling data for the plurality of graphs stored in the second storage device 150. Further, in the second layer 220, the operation 320 of executing the query 101 in the query processing device 100 and the query operation engine 221 may include an operation of performing an operation on data of a plurality of graphs.

Accordingly, the query processing device 100 according to various embodiments of the present disclosure may call required data from each graph by performing an operation of extracting and storing a plurality of graphs, and process the query 101 using the called data. Therefore, the query processing device 100 may efficiently process interactive queries that need to analyze several graphs in real time.

In addition, the query processing device 100 according to various embodiments of the present disclosure may provide a composite graph analysis function in which data of different domains are connected, by processing the query 101 in a heterogeneous graph at once. Accordingly, the query processing device 100 may analyze broader relationships than a single graph traversal by simultaneously traversing several graphs.

FIG. 4 is an illustrative diagram illustrating the first storage device and the second storage device according to the embodiment of the present disclosure.

Referring to FIG. 4, the first storage device 140 may store data of a relational database 441, and the second storage device 150 may store a graph topology 451.

The relational database 441 is a type of database that stores and manages data in the form of a structured table. The relational database 441 may be a set of interrelated tables. Specifically, the respective tables included in the relational database 441 may be an independent data unit but may be connected to each other using foreign keys.

The relational database 441 may include a row, a column, a primary key, and a foreign key. The row may represent a single data item and correspond to an entity and tuple in a table. For example, the first storage device 140 may store a UserT table and a PostT table PT, each including two tuples. The column may represent a specific property of the data and define a structure of the table. For example, the UserT table may include an “ID” property and a “name” property, and the PostT table may include an “ID” property, a “content” property, and a “creation date” property. The primary key may be a property for uniquely identifying each row.

Referring to FIG. 4, the graph topology 451 may include a pattern of the graph and a connection relationship information between elements constituting the graph. Specifically, the graph topology 451 may include IDs of the vertex and the edge, labels, connection relationship data 453 between the graph elements, and connection relationship data 455 between the graph elements and the relational database.

The graph topology 451 may be stored in the form of a vertex record and an edge record. The vertex record and the edge record may include a plurality of data fields that store different types of data. Specifically, the vertex record and the edge record may include a plurality of data fields in which component IDs, labels, and connection relationship data 453 among graph elements are stored, and a data field in which connection relationship data 455 between the graph elements and the relational database are stored. For example, the vertex record may include a header field (header), an ID field (vertex ID), a label field (label), at least one output edge pointer field (first out-edge-ptr1), at least one input edge pointer field (first in-edge-ptr1), and a property tuple pointer field (property-tuple-ptr). The edge record may include a header field (header), an ID field (edge ID), a label field (label), a source vertex pointer field (sic-vertex-ptr), a destination vertex pointer field (dst-vertex-ptr), a next output edge pointer field (next out-edge-ptr), a next input edge pointer field (next in-edge-ptr), and a property tuple pointer field (property-tuple-ptr).

Referring to FIG. 4, the connection relationship data 453 between the graph elements indicates a scheme of connecting the vertices to the edges. For example, the connection relationship data 453 between the graph elements may be stored in the at least one output edge pointer field and the at least one input edge pointer field of the vertex record, and in the source vertex pointer field, the destination vertex pointer field, the next output edge pointer field, and the next input edge pointer field of the edge record.

The output edge pointer field may store an address of at least one edge output from the corresponding vertex, and the input edge pointer field may store an address of at least one edge input to the corresponding vertex. In some cases, the output edge pointer field and the input edge pointer field may include one subfield for each label type of edges in the graph. For example, since a post vertex P may have a Likes edge L and a ReplyOf edge R, the post vertex record may include a first input edge pointer field for storing an address of the Likes edge L input to the post vertex P and a second input edge pointer field for storing an address of the ReplyOf edge R input to the post vertex P. When a plurality of Likes edges L are input to one post vertex P, an address of the most recently created Likes edge L may be stored in the first input edge pointer field of the post vertex record.

The next output edge pointer field of the edge record may store an address of a next edge output from a source vertex stored in the source vertex pointer field, and the next input edge pointer field may store an address of a next edge input to a destination vertex stored in the destination vertex pointer field. That is, the next output edge pointer field of the edge record may store data related to the next edge output together with the corresponding edge, and the next input edge pointer field may store data related to the next edge input together with the corresponding edge. For example, when a Likes edge L with ID=2 and a Likes edge L with ID=1 are input to a post vertex P with ID=3, a Likes edge record with ID=2 may store data related to the Likes edge L with ID=1 in the next input edge pointer field.

Referring to FIG. 4, the connection relationship data 455 between the graph elements and the relational database defines a scheme for connecting the vertex record and the edge record to the tables of the relational database. For example, the connection relationship data 455 between the graph elements and the relational database may be stored in the property-tuple pointer field of the vertex records and the property-tuple pointer field of the edge records.

The property-tuple pointer field may store addresses of the tables in the relational database 441 connected to the corresponding vertex and edge. Specifically, the property-tuple pointer field of the vertex record may store an address of the relational table connected to the vertex record, and the property-tuple pointer field of the edge record may store an address of the relational table connected to the edge record. For example, a property-tuple pointer field of a user vertex U record may store an address of a UserT table UT in which the property information of the vertex is stored.

The query processing device 100 according to the embodiment of the present disclosure may include the vertex record and the edge record containing the connection relationship data 453 between the graph elements, enabling sequential traversal of the graph patterns.

Further, the query processing device 100 according to the embodiment of the present disclosure includes the vertex record including one output edge pointer field and one input edge pointer field for each label type of edges connectable to the corresponding vertex, thereby maintaining a constant size of the vertex record even when a plurality of edges are concentrated on a specific vertex. Accordingly, the query processing device 100 can maintain uniform data access performance for a plurality of vertex records while efficiently managing the storage space.

Further, the query processing device 100 includes the vertex record including the output and input edge pointer fields and the edge record including the next output and input edge pointer fields, thereby storing all graph patterns as a consistent dataset. Accordingly, the query processing device 100 can minimize data access required during specific pattern traversal and improve graph traversal performance.

FIG. 5 is a table showing the integrated operator according to the embodiment of the present disclosure.

Referring to FIG. 5, the query processing device 100 according to the embodiment of the present disclosure may perform an operation of processing the query 101 by using the integrated operator 522 that performs at least one of the traversal, join, and mapping operations according to the operation table 525.

The operation of processing the query 101 by using the integrated operator 522 that performs at least one of the traversal, join, and mapping operations according to the operation table 525 may include an operation OP1 of performing a traversal operation on the first operand H₁ and the second operand H₂ when both the first operand H₁ and the second operand H₂ are graph elements including at least one of a set of vertices stored in the second storage device 150 and a set of edges stored in the second storage device 150, an operation OP2 of performing the join operation on the first operand H₁ and the second operand H₂ when both the first operand H₁ and the second operand H₂ are relational data stored in the relational database of the first storage device 140, an operation OP3 of performing a first mapping operation between the graph element of the first operand H₁ and the relational database of the second operand H₂ when the first operand H₁ is the graph element and the second operand H₂ is the relational data, and an operation OP4 of performing a second mapping operation between the relational database of the first operand H₁ and the graph element of the second operand H₂ when the first operand H₁ is the relational database and the second operand H₂ is the graph element.

Specifically, when both the first operand H₁ and the second operand H₂ are the graph elements stored in the second storage device 150, the integrated operator 522 may traverse the graph pattern by using connection relationship data between graph elements that are stored in the vertex record or the edge record of the operand. When both the first operand H₁ and the second operand H₂ are data of the relational database stored in the first storage device 140, the integrated operator 522 may perform the join operation on a table of the first operand H₁ and a table of the second operand H₂. When the first operand H₁ is the graph element and the second operand H₂ is the data of the relational database, the integrated operator 522 may retrieve an address of the relational table connected to the record by using a property-tuple pointer field included in the record of the first operand H₁, and perform a mapping operation on the record and the relational table at the retrieved address. When the first operand H₁ is the data of the relational database and the second operand H₂ is the graph element, the integrated operator 522 may search, using various methods, the record of the second operand H₂ including the property-tuple pointer field in which an address of the first operand H₁ is stored, and perform a mapping operation on the record of the second operand H₂ that has been searched for and the first operand H₁. The various methods may include a nested-loop join algorithm, an index join algorithm, a hash join algorithm, and a sort merge join algorithm.

The query processing device 100 according to the embodiment of the present disclosure may include the integrated operator 522 capable of performing the traversal, join, and mapping operations according to a data type of operand, thereby preventing an unnecessary data conversion process. Accordingly, the query processing device 100 may process the traversal, join, and mapping operations through a single integrated operator without the unnecessary data conversion process, thereby improving query processing performance for complex queries.

In addition, the query processing device 100 according to the embodiment of the present disclosure may include the integrated operator 522 capable of selectively performing the traversal, join, and mapping operations according to the data type of the operand, thereby performing an optimal operation suitable for data characteristics of the operand.

FIG. 6 is an illustrative diagram illustrating an example of generating a query processing plan according to the embodiment of the present disclosure, and FIG. 7 illustrates a subplan table showing an operation of generating subplans by gradually increasing a size according to the embodiment of the present disclosure.

Referring to FIGS. 6 and 7, the query processing device 100 may perform an operation of generating the query processing plan. Specifically, the query processing device 100 may perform an operation of generating the query processing plan based on the data required for execution of the query 101. More specifically, the query processing device 100 may perform an operation of generating the query processing plan based on the operands and the operation relationship information between the operands defined by the query 101.

The operation of generating the query processing plan may include an operation 610 of generating at least one subplan 610 for the query 101 in the query processing device 100, and an operation 620 of determining the optimal query processing plan 621 based on cost. Specifically, the operation of generating the query processing plan may include an operation in which the query processing device 100 generates possible operation order combinations between the operands as respective subplans and calculates a cost of each subplan, and an operation of selecting, as the optimal query processing plan, the subplan requiring the least cost among the costs of the respective subplans. More specifically, the operation of generating the query processing plan may include an operation in which the query processing device 100 generates each operation order combination as one subplan by considering all the possible operation order combinations between the operands and calculates a cost of each subplan, and an operation of selecting an optimal subplan requiring the least cost among all the possible operation order combinations. That is, the operation 610 of generating at least one subplan for the query 101 may include an operation of generating possible operation order combinations among operands as each subplan, and an operation of calculating a cost of each subplan.

The operation of generating possible operation order combinations among operands as each subplan may include any one of an operation of generating each operation order combination as one subplan for all possible operation order combinations between the operands, and an operation of generating each operation order combination as one subplan for at least some of the operation order combinations between the operands based on a specific rule.

The operation of generating each operation order combination as one subplan for all the possible operation order combinations between the operands and the operation of calculating the cost of each subplan may include any one of an operation of generating each operation order combination for all the possible operation order combinations between the operands as one subplan and calculating the cost of each generated subplan, and an operation of generating subplans for all possible operation order combinations between the operands while gradually increasing sizes of the subplans and efficiently calculating costs of relatively large subplans by utilizing costs of relatively small subplans. Accordingly, the query processing device 100 according to the embodiment of the present disclosure can derive an optimal execution order with the smallest cost by calculating the costs for all the possible operation order combinations between the operands. Therefore, the query processing device 100 generates the optimal execution order having the smallest cost as the query processing plan, thereby reducing the time and cost required to process the query 101.

The operation of generating each operation order combination as one subplan for all possible operation order combinations between the operands based on the specific rule and the operation of calculating the cost of each subplan may include any one of an operation of generating the subplan by preferentially considering an operation highly likely to have a low cost through empirical rules and calculating a cost of each subplan, an operation of generating subplans for some of the operation order combinations by applying a rule that empirically yields good results and calculating a cost of each subplan, and an operation of selectively generating subplans for probabilistically good operation order combinations and calculating a cost of each subplan. For example, the query processing device 100 may approximately derive an optimal operation order combination based on a genetic algorithm.

Accordingly, the query processing device 100 according to the embodiment of the present disclosure can rapidly approximate and derive the best operation order combination without traversing all possible operation order combinations, thereby quickly generating the query processing plan even when the number of operations is large. Therefore, the query processing device 100 can reduce the time and cost required to generate the query processing plan, thereby reducing the time and cost required to process the query 101.

Further, the query processing device 100 according to the embodiment of the present disclosure traverses only at least some of operation order combinations and measures the costs, thereby reducing an amount of memory usage. Accordingly, the query processing device 100 can generate the query processing plan without memory shortage even for a relatively large scale query 101 having many operation order combinations.

The operation of generating subplans for all possible operation order combinations between the operands while gradually increasing sizes of the subplans and efficiently calculating costs of relatively large subplans by utilizing costs of relatively small subplans may include an operation in which the query processing device 100 generates a first subplan including an operation relationship between a first operand S₁ with a degree (deg) of 1 or more and a second operand S₂ with a degree (deg) of 1 or more based on a query operation structure 611 in which operation relationships among a plurality of operands are defined, and an operation of generating a second subplan in which a degree (deg) of at least one of the first operand S₁ and the second operand S₂ of the first subplan is increased. For example, as shown in a subplan table 700, the query processing device 100 may generate a first subplan ({U}, ⊗→, {L}) including an operation relationship between the first operand S₁ including {U} with a degree (deg) of 1 and the second operand S₂ including {L} with a degree (deg) of 1. In some cases, the query processing device 100 may also generate a second subplan ({U}, ⊗→, {L, P1v}) including an operation relationship between the first operand S₁ including {U} with a degree (deg) of 1 and the second operand S₂ including {L, P1v} with a degree (deg) of 2.

Referring to FIGS. 6 and 7, the operation 620 of determining the optimal query processing plan 621 based on costs may include an operation of calculating the costs required to execute each subplan in the query processing device 100, and an operation of selecting the optimal subplan combination requiring the lowest cost. In some cases, the operation 620 of determining the optimal query processing plan 621 based on costs may include an operation of calculating a cost required to execute each subplan by degree, and an operation of determining, as the optimal query processing plan 621, the subplan that requires the least cost by comparing execution costs of the respective subplans. For example, as shown in the subplan table 700, when a plan that sequentially executes the first subplan ({U}, ⊗→, {L}) and the second subplan ({U, L}, ⊗→, {P1_{V}}) to a seventh subplan ({U, L, P1_{V}, P1_{T}, P2_{T}, P2_{V}, R}, ⊗←, {R}) requires a minimum cost, the query processing device 100 may determine a query operation structure 611 that sequentially performs an operation from the operand {U} to the operand {C} as the optimal query processing plan 621. That is, in the operation of determining the optimal query processing plan 621, the respective subplans for which the execution costs are compared may be a union of a plurality of subplans.

The query processing device 100 according to the embodiment of the present disclosure determines operation combinations while gradually increasing the subplan, thereby utilizing a cost of a subplan of a lower degree that has been previously calculated for the cost of the subplan of a higher degree. Accordingly, the query processing device 100 can explore optimal execution orders while omitting unnecessary redundant operation and saving memory and computational resources.

Further, the query processing device 100 according to the embodiment of the present disclosure can efficiently optimize various types of complex queries by optimizing all of the traversal, join, and mapping operations in an integrated manner. When the graph queries and the relational database queries are optimized separately, additional cost and delay may occur in a step of binding the optimized graph queries and the optimized relational queries. On the other hand, the query processing device 100 according to the embodiment of the present disclosure can derive the most optimized query processing plan by optimizing both the data of the relational database and the graph data together.

The operation of calculating the cost required to execute each subplan may vary depending on sizes of the operands and a type of operation between operands. Specifically, the operation of calculating the cost required to execute each subplan may include at least one of an operation of calculating the cost of the traversal operation using the integrated operator based on the number of traversal start points, a disc I/O cost, a CPU operation cost, and a buffer cache effect, an operation of calculating the cost of the join operation using the integrated operator based on a size of the participating table, the disc I/O cost, the CPU operation cost, and a size of an intermediate result, and an operation of calculating the cost of the mapping operation using the integrated operator based on the pointer traversal cost, the disc I/O cost, and the CPU operation cost.

The operation of calculating the cost of the traversal operation using the integrated operator may include an operation of calculating a total sum of the cost of traversing adjacent elements of the first operand S₁ and the cost of performing an intersection operation on the traversed adjacent elements of the first operand S₁ and the second operand S₂. For example, the cost of traversing the adjacent elements of the first operand S₁ may be a total sum of the cost of performing an operation on the first operand S₁, a disc access cost for loading each adjacent element of the elements output as a result of operating the first operand S₁, and a CPU operation cost required to perform an operation on adjacent elements of each element output as the operation result.

In the operation of calculating the cost of the traversal operation using the integrated operator, the disc access and computation costs may be weighted by reflecting an average connection degree (d) of the vertices when the traversal operation starts from the vertex and expands to the edge. Specifically, when the traversal operation proceeds in a direction from the edge to the vertex, the number of adjacent elements is one, whereas when the traversal operation proceeds in a direction from the vertex to the edge, the number of adjacent elements may be an average of d, and thus the disc access and computation costs may be weighted by reflecting the average connection degree (d) of the vertices in the operation of calculating the cost of the traversal operation using the integrated operator.

The operation of calculating the cost of the join operation in the integrated operator may be a sum of a cost of performing the first operand S₁, a cost of performing the second operand S₂ for each tuple output as the operation result of the first operand S₁, and a CPU operation cost for comparing the respective output tuples and finding matching data.

The operation of calculating a cost of the first mapping operation (G2R mapping) in the integrated operator may be a total sum of the cost of performing the first operand S₁ and a disc I/O cost for the elements output as an operation result of the first operand S₁.

The operation of calculating a cost of the second mapping operation (R2G mapping) in the integrated operator may be substantially similar to the operation of calculating the cost of the join operation. In some cases, the query processing device 100 may calculate costs of various schemes including a nested-loop join algorithm, an index join algorithm, a hash join algorithm, and a sort-merge join algorithm, and select a second mapping scheme that is most efficient.

The query processing device 100 according to the embodiment of the present disclosure compares the costs of the traversal, join, and mapping operations, thereby accurately determining the optimal query processing plan using the integrated operator.

Further, the query processing device 100 according to the embodiment of the present disclosure may calculate an accurate operation cost according to a traversal direction by calculating the traversal operation cost reflecting the number of traversal start points and the average connection degree d. That is, in the case of traversal that starts from the vertex and expands to the edge, the query processing device 100 may apply a weight to the processing cost compared to the traversal that starts from the edge and proceeds to the vertex, thereby calculating a more accurate cost according to the traversal direction.

The query processing device 100 according to the embodiment of the present disclosure may perform all of the traversal, join, and mapping operations for the query 101 using the integrated operator, thereby performing the operations for the query 101 within a single layer. Thus, the query processing device 100 performs the traversal, join, and mapping operations for the query 101 within the single second layer 220, thereby minimizing unnecessary data movement between different layers. Accordingly, the query processing device 100 minimizes unnecessary data movement between the different layers, thereby preventing data transfer costs from occurring and improving operation speed.

Further, the query processing device 100 according to the embodiment of the present disclosure can dynamically optimize an order of the traversal, join, and mapping operations by performing the traversal, join, and mapping operations for the query 101 within the single second layer 220. When the join operation and the traversal operation are performed in separate layers, there is a problem that the join operation or the traversal operation needs to be performed separately before the mapping operation is performed, or the mapping operation needs to be performed before the join operation or the traversal operation is performed in order to minimize occurrence of costs due to data movement between the layers or data movement between the engines. Accordingly, when the join operation and the traversal operation are performed in separate layers, additional costs may occur, or inefficiencies in query optimization may arise. On the other hand, the query processing device 100 according to the embodiment of the present disclosure dynamically optimizes the execution order of the traversal, join, and mapping operations within the single layer, thereby deriving the most optimized query processing plan.

Further, the query processing device 100 according to the embodiment of the present disclosure performs the update and synchronization operations for the first storage device 140 and the second storage device 150 using the integrated transaction manager 232, thereby performing real-time synchronization between the storage devices and processing queries in a state in which the latest data is reflected.

In addition, the query processing device 100 according to the embodiment of the present disclosure batch-processes the update and synchronization operations for the first storage device 140 and the second storage device 150 using the single integrated transaction manager 232, thereby more effectively ensuring the ACID properties between the first storage device 140 and the second storage device 150. When a separate transaction manager exists in each storage device, additional network and computation costs for coordinating transactions may occur and data synchronization may be delayed depending on an update cycle of each transaction manager. On the other hand, the query processing device 100 according to the embodiment of the present disclosure may perform the update and synchronization operations for the first storage device 140 and the second storage device 150 using the single integrated transaction manager 232, thereby reducing unnecessary delays and performing fast data insertion, modification, and deletion operations.

Further, the query processing device 100 according to the embodiment of the present disclosure stores the graph topology in a storage device separate from the relational database, thereby avoiding an addition operation of converting the graph query into the relational database query and preventing excessive increase in the join operation between tables. That is, the query processing device 100 directly executes the graph query using the graph data called from the second storage device 150, thereby omitting the addition operation of converting the graph query into the database query. Accordingly, the query processing device 100 executes the graph query without the addition operation of converting the graph query into the database query, thereby executing the composite query more efficiently.

Further, the query processing device 100 according to the embodiment of the present disclosure stores the graph topology in the second storage device 150 based on a disc, thereby increasing a size of an analyzable graph. When the graph data is stored in a memory rather than on a disc-based medium, the size of analyzable graphs may be limited by a size of the memory. On the other hand, the query processing device 100 stores the graph topology in the second storage device 150 based on a disc having a relatively large capacity, thereby executing a relatively large-scale graph.

Further, the query processing device 100 according to the embodiment of the present disclosure stores the graph topology in the second storage device 150 based on a disc suitable for OLTP, thereby easily performing data insertion, update, and deletion operations. When the graph data is stored in a memory optimized for a read operation, the graph data is difficult to change and a delay may occur in reflecting the latest data. On the other hand, the storage engine 231 of the query processing device 100 according to the embodiment of the present disclosure updates the graph topology stored in the second storage device 150 in real time, thereby processing the queries based on a graph reflecting the latest data. Therefore, the query processing device 100 can rapidly and accurately process interactive queries based on the graph topology updated in real time.

Further, the query processing device 100 according to the embodiment of the present disclosure stores the property data of the relational database and the graph topology in the first storage device 140 and the second storage device 150 based on a disc suitable for OLTP, thereby efficiently synchronizing the property data of the relational database and the graph topology. When the property data is stored on a disc and the graph topology is stored in a memory, the ACID properties between the property data and the graph topology may not be guaranteed. On the other hand, the query processing device 100 according to the embodiment of the present disclosure simultaneously updates the first storage device 140 and the second storage device 150 based on a disc suitable for OLTP on a transaction basis, thereby more effectively guaranteeing the ACID properties of the property data of the relational database and the graph topology.

Moreover, the query processing device 100 according to the embodiment of the present disclosure stores the graph topology and the data of the relational database in separate storage devices, thereby utilizing both the graph topology and the data of the relational database as first-class citizens of equal importance. Accordingly, the query processing device 100 processes both the graph topology and the data of the relational database as the first-class citizens, thereby efficiently optimizing the composite query. When the optimization of the graph queries and the optimization of the relational database queries are executed separately, additional cost and delay may occur in a step of binding the optimized graph queries and the optimized relational queries. On the other hand, the query processing device 100 according to the embodiment of the present disclosure optimizes both the relational database queries and the graph queries included in the composite query in a single layer instead of separately optimizing the queries, thereby executing the composite query using the most optimized plan.

Further, the query processing device 100 according to the embodiment of the present disclosure includes the vertex record including one output edge pointer field and one input edge pointer field for each label type of edges connectable to the corresponding vertex, thereby maintaining a constant size of the vertex record even when a plurality of edges are concentrated on a specific vertex. Accordingly, the query processing device 100 can maintain uniform data access performance for a plurality of vertex records while efficiently managing the storage space.

Further, the query processing device 100 includes the vertex record including the output and input edge pointer fields and the edge record including the next output and input edge pointer fields, thereby storing all graph patterns as a consistent dataset. Accordingly, the query processing device 100 can minimize data access required during specific pattern traversal and improve graph traversal performance.

Further, the query processing device 100 according to the embodiment of the present disclosure may include the integrated operator 522 capable of performing the traversal, join, and mapping operations according to a data type of an operand, thereby preventing an unnecessary data conversion process. Accordingly, the query processing device 100 may process the traversal, join, and mapping operations through a single integrated operator without the unnecessary data conversion process, thereby improving query processing performance for complex queries.

Further, the query processing device 100 according to the embodiment of the present disclosure may calculate a cost of all sub-plans for the respective operation relationships defined by the query operation structure 611, thereby determining the optimal execution order that allows the cost of operations to be minimized.

Further, the query processing device 100 according to the embodiment of the present disclosure can efficiently optimize various types of complex queries by optimizing all of the traversal, join, and mapping operations in an integrated manner. When the graph queries and the relational database queries are optimized separately, additional cost and delay may occur in a step of binding the optimized graph queries and the optimized relational queries. On the other hand, the query processing device 100 according to the embodiment of the present disclosure can derive the optimal query processing plan by optimizing both the data of the relational database and the graph data together.

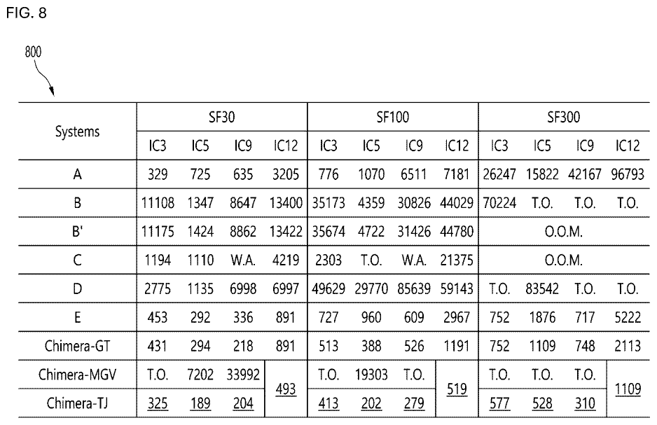

FIG. 8 is a table showing response time performance of the query processing device according to the embodiment of the present disclosure.

Referring to FIG. 8, the query processing device according to the embodiment of the present disclosure corresponds to a query processing device that performs a Chimera-TJ method (hereinafter referred to as a Chimera-TJ query processing device). Accordingly, the performance of the query processing device 100 can be verified through the query processing performance of the Chimera-TJ query processing device based on an LDBC SNB dataset. Specifically, the query processing performance of the Chimera-TJ query processing device can be compared with the query processing performance of company A, company B, company B′, company C, company D, company E, Chimera-GT, and Chimera-MGV (hereinafter referred to as company A, company B, company B′, company C, company D, company E, Chimera-GT, and Chimera-MGV), based on the LDBC SNB dataset.

The Chimera-GT is a query processing device that processes queries using a GT-type execution plan in the same query processing device as the Chimera-TJ query processing device, and the Chimera-MGV is a query processing device that processes queries using an MGV-type execution plan in the same query processing device as the Chimera-TJ query processing device. The GT-type execution plan is a scheme for traversing a graph using nested-loop (INL) join of a traditional RDBMS, and may include an operation of converting all graph queries into relational database queries and processing the queries. The MGV-type execution plan is a scheme for performing operations after generating a graph view in advance when executing a query, and may include an operation of performing the traversal operation through the graph view stored in the memory.

Companies A and B are RDBMS-based query processing devices and can indirectly perform graph traversal using graph data stored as a table using relational database queries. Companies B′ and C are MGV-type graph-relational query processing devices, and companies D and E may be GT-based graph-relational query processing devices. Company B′ may be a device obtained by adding extended functions related to graph query processing to company B. In the case of an MGV-type query processing device, the graph view generation time is excluded from the response time.

Referring to FIG. 8, a response time performance table 800 represents an average execution time required for each query processing device to process a query on the LDBC SNB dataset having a scale of SF=30, SF=100, and SF=300. T.O. (Time Out) may indicate a case in which the execution time is 100,000 ms (100 seconds) or more, W.A. (Wrong Answer) may indicate a case in which the result does not match that of another system, and O.O.M. (Out of Memory) may indicate a case in which execution fails due to insufficient memory. The input query may be an interactive complex query (IC) of an LDBC SNB benchmark.

It can be seen from FIG. 8 that the Chimera-TJ query processing device exhibits the best performance in all experiments with scales of SF=30, SF=100, and SF=300. Specifically, although the Chimera-GT adopting a GT scheme and company E exhibit performance relatively close to that of the Chimera-TJ query processing device, the Chimera-TJ query processing device achieves up to 1.89 times higher performance improvement than the Chimera-GT on a relatively small scale of SF=30, and achieves up to 4.71 times higher performance improvement than company E even on a relatively large scale of SF=300. When some IC queries include only a small number of topology operations, a GT-based query processing device such as the Chimera-GT and company E may exhibit query processing performance relatively similar to that of the Chimera-TJ query processing device. However, the GT-based query processing device has a problem in that additional cost occurs when finding adjacent vertices and next edges through the join operation. On the other hand, the Chimera-TJ query processing device performs the traversal operation using the integrated operator, allowing adjacent vertices and next edges to be traversed without additional cost. Therefore, the Chimera-TJ query processing device can consistently maintain higher performance compared with the GT-based query processing device.

It can be seen from FIG. 8 that companies B′ and C based on the MGV have failed to execute due to insufficient memory on a relatively large scale of SF=300. Since companies B′ and C based on the MGV dynamically generate a graph view in a memory (RAM), query processing becomes impossible for a large-scale dataset such as SF=300. Further, companies B′ and C based on the MGV may require a significant amount of time to generate the graph view. For example, at SF=100, company B′ took up to 457,409 msec to generate the graph view, and company C took up to 153,192 msec to generate the graph view. On the other hand, the Chimera-TJ query processing device processes graph queries directly based on the graph data stored in the second storage device, thereby processing large-scale graphs regardless of a memory size and not requiring separate graph view generation time. Meanwhile, it can be seen that companies A and B based on RDBMS and company D based on GT show an overwhelming increase in query processing time due to the increased complexity of the join operation as a size of the dataset increases. On the other hand, the Chimera-TJ query processing device can achieve high query processing performance even for relatively large-scale datasets by integrally optimizing the traversal, join, and matching operations through the integrated operator.

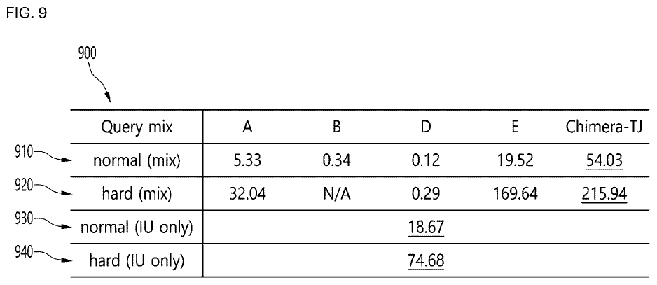

FIG. 9 is a table showing throughput performance of the query processing device according to the embodiment of the present disclosure.

Referring to FIG. 9, in a performance evaluation experiment of the Chimera-TJ query processing device according to the present embodiment, a query mix for executing eight read queries (IC, IS) and four write queries (IU) may be performed to measure throughput in the performance evaluation experiment of the Chimera-TJ query processing device shown in FIG. 8. The throughput may be measured based on the number of queries executed per second (ops/sec). Meanwhile, since the MGV scheme does not support transaction update and therefore query mix cannot be performed, throughput performance of the Chimera-TJ query processing device is shown in comparison with that of Company A and Company B based on RDBMS and Company D and Company E based on GT.

Referring to FIG. 9, a throughput performance table 900 includes throughput measurement results for a general query mix 910, a high-intensity query mix 920 in which the number of threads and workload intensity are set higher than in the general query mix, a write-only IU query 930 including only write queries IU without read queries, and a high-intensity write-only IU query 940.

Referring to FIG. 9, it can be seen, from experimental results for the general query mix 910 and the high-intensity query mix 920, that the Chimera-TJ query processing device has achieved the highest performance among all comparison targets. In particular, the Chimera-TJ query processing device exhibits up to 779 times performance improvement compared with company D. All query processing devices other than the Chimera-TJ query processing device may experience a delayed execution phenomenon. That is, since all the comparison targets are still processing previous queries, current queries are not executed according to a schedule. On the other hand, the Chimera-TJ query processing device has fast response-time performance, thereby preventing the delayed execution phenomenon and maintaining high throughput performance. In particular, it can be seen, from the result of the high-intensity query mix 920 in which the workload intensity is increased from TCR=1 to TCR=0.25, that the Chimera-TJ query processing device achieves a throughput of 215.9 ops/sec, thereby exhibiting ideal improvement of performance in which the throughput increases by four times from a previous throughput.

Referring to FIG. 9, the throughput performance table 900 includes measurement results in which both the Chimera-TJ query processing device and all the comparison targets have achieved ideal performance without delayed execution in results of performing the write-only IU query 930 and the high-intensity write-only IU query 940. Accordingly, the Chimera-TJ query processing device not only exhibits overwhelming processing results compared with all the comparison targets in an operation of processing the query-mixes 910 and 920, but also achieves the same ideal performance as all the comparison targets in an operation of processing the write-only queries 930 and 940.

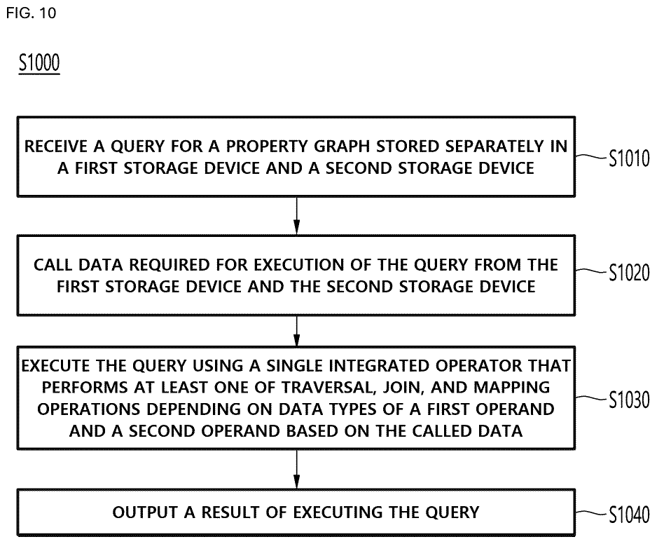

FIG. 10 is a flowchart illustrating a query processing method S1000 according to the embodiment of the present disclosure.

Referring to FIG. 10, the query processing method S1000 is a method of processing a query in a query processing device including at least one memory including a plurality of instructions, a first storage device in which property information for vertices and edges is stored in relational tables, a second storage device in which a vertex record including connection information of the vertices in a graph and an edge record including connection information of edges in the graph are stored, and at least one processor electrically connected to the at least one memory and configured to execute the plurality of instructions, the method including: an operation S1010 of receiving a query for a property graph stored separately in the first storage device and the second storage device, an operation S1020 of calling data required for execution of the query from the first storage device and the second storage device, an operation S1030 of performing an operation on the query using a single integrated operator that performs at least one of traversal, join, and mapping operations depending on data types of a first operand and a second operand based on the called data, and an operation S1040 of outputting a result of executing the query. The integrated operator may selectively perform the traversal, join, and mapping operations within a single query processing layer.

The operation of performing an operation on the query using the integrated operator may include: an operation of performing a traversal operation on the first operand and the second operand when both the first operand and the second operand are graph elements including at least one of a set of vertices stored in the second storage device and a set of edges stored in the second storage device, an operation of performing a join operation on the first operand and the second operand when both the first operand and the second operand are relational data stored in the relational table of the first storage device, an operation of performing a first mapping operation between the graph element of the first operand and the relational database of the second operand when the first operand is the graph element and the second operand is the relational data, and an operation of performing a second mapping operation between the relational database of the first operand and the graph element of the second operand when the first operand is the relational database and the second operand is the graph element.

In some cases, the query processing method S1000 may further include an operation of integrating update requests corresponding to both the first storage device and the second storage device and processing the update requests in one transaction. The operation of processing the update requests in one transaction may include an operation of receiving a label and a property of a graph element to be inserted into the first storage device and the second storage device, a first storage device update operation of storing the property of the graph element to be inserted in the relational table of the first storage device, and a second storage device update operation of storing the label of the graph element to be inserted into a label field of the vertex record or the edge record of the second storage device, and storing the address of the relational table in which the graph element to be inserted is stored in the property-tuple pointer field of the vertex record or edge record. The operation of processing the update requests in one transaction may include an operation of recording content of the update requests for the first storage device and the second storage device, and an operation of restoring all changes reflected in the first storage device and the second storage device to original states based on the recorded content of update requests when an error occurs in the update operation of the first storage device or the second storage device.

The query processing method S1000 may include an operation of generating the query processing plan based on the first operand, second operand, and integrated operator. The operation of generating the query processing plan may include an operation of calculating the cost for all possible operation combinations while gradually increasing the size of the subplan based on the first operand, and an operation of selecting an optimal subplan that requires the least cost among all of the possible operation combinations

The operation of calculating the cost may include at least an operation of calculating the cost of the traversal operation using the integrated operator based on the number of traversal start points, a disc I/O cost, a CPU operation cost, and a buffer cache effect, an operation of calculating the cost of the join operation using the integrated operator based on a size of the participating table, the disc I/O cost, the CPU operation cost, and a size of an intermediate result, and an operation of calculating the cost of the mapping operation using the integrated operator based on the pointer traversal cost, the disc I/O cost, and the CPU operation cost. The operation of calculating the cost of the traversal operation may include an operation of weighting disc access and operation costs by reflecting the average connection degree of vertices when a traversal direction of the traversal operation proceeds from the vertex to the edge.

In the present disclosure, each block may represent a part of a module, segment, or code including one or more executable instructions for executing specific logical function(s). Further, in some alternative embodiments, it should be noted that the functions mentioned in the blocks may occur out of order. For example, two blocks shown in succession may in fact be executed substantially simultaneously, or the blocks or steps may sometimes be executed in reverse order depending on the corresponding functions.

The steps of the methods or algorithms described in connection with the embodiments disclosed herein may be directly implemented by hardware and software modules executed by a processor, or by a combination thereof. For example, the devices, methods, and components described in the embodiments may be implemented using a general-purpose computer or a special-purpose computer, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may execute an operating system (OS) and software applications executed on the OS. Further, the processing device may access, store, manipulate, process, and generate data in response to the execution of software. For convenience of understanding, one processing device has been described as being used in some cases, but those skilled in the art will appreciate that the processing device may include a plurality of processing elements and/or a plurality of types of processing elements. For example, the processing device may include a plurality of processors or one processor and one controller. Further, other processing configurations, such as a parallel processor, are also possible.

The software may include a computer program, code, instructions, or any combination thereof, and may configure a processing device to operate as desired or command the processing device independently or collectively. The software and/or data may be embodied permanently or temporarily in any type of machine, component, physical device, virtual equipment, computer storage medium or device, or transmitted signal waves, to be interpreted by the processing device or to provide instructions or data to the processing device. The software may also be distributed across computer systems connected via a network, and stored or executed in a distributed manner. The computer program, software, and data may be stored on a computer-readable recording medium.

The method according to the embodiment may be implemented in the form of program instructions that can be executed through various computer means and may be recorded on a computer-readable medium. The computer-readable medium may store program instructions, data files, data structures, and the like alone or in combination, and the program instructions recorded on the medium may be those specially designed and configured for the embodiments or may be those known and available to a person skilled in computer software. Examples of the computer-readable recording medium include hardware devices specially configured to store and execute program instructions, including magnetic media such as hard disks, floppy disks, and magnetic tapes, optical media such as CD-ROMs and DVDs, magneto-optical media such as floptical discs, ROMs, RAMs, flash memories, registers, or any other type of storage medium known in the art. An exemplary recording medium may be coupled to a processor, which may read information from or write information to the storage medium. Alternatively, the storage medium may be integrated with the processor. The processor and the storage medium may reside within an application-specific integrated circuit (ASIC). The ASIC may reside within a user terminal. Alternatively, the processor and the storage medium may reside as separate components within the user terminal. Examples of the program instructions include not only machine code as generated by a compiler but also high-level language code that can be executed by a computer using an interpreter or the like.

The hardware device described above may be configured to operate as one or more software modules to perform the operations of the embodiments, and vice versa.

According to at least one means for achieving the object of the present disclosure, the query processing device selectively performs the traversal, join, and mapping operations for the query using the integrated operator, thereby performing operations on the query within a single layer.

According to at least one means for achieving the object of the present disclosure, the query processing device performs the traversal, join, and mapping operations for a query within a single second layer, thereby minimizing unnecessary data movement between different layers.

According to at least one means for achieving the object of the present disclosure, the query processing device minimizes unnecessary data movement between different layers, thereby reducing data movement costs and improving processing speed.

According to at least one means for achieving the object of the present disclosure, the query processing device performs the update and synchronization operation for the first storage device and the second storage device using an integrated transaction manager, thereby performing real-time synchronization between storage devices and processing queries in a state in which the latest data is reflected.

According to at least one means for achieving the object of the present disclosure, the query processing device stores the graph topology in a storage device separate from the relational database, thereby avoiding an addition operation of converting the graph query into the relational database query and preventing excessive increase in the join operation between tables.

According to at least one means for achieving the object of the present disclosure, the query processing device optimizes both the relational database queries and the graph queries included in the composite query in a single layer instead of separately optimizing the queries, thereby executing the composite query using the most optimized plan.

According to at least one means for achieving the object of the present disclosure, the query processing device can efficiently optimize various types of complex queries by optimizing all of the traversal, join, and mapping operations in an integrated manner.

The effects that can be obtained from the present disclosure are not limited to those mentioned above, and other effects that are not mentioned will be clearly understood by those skilled in the art from the description.

Although embodiments of the present disclosure have been described in detail above with reference to the accompanying drawings, the present disclosure is not limited to these embodiments, and various modifications may be made without departing from the technical spirit of the present disclosure. Therefore, the embodiments disclosed herein are not intended to limit the technical spirit of the present disclosure but to describe the technical spirit, and the scope of the technical spirit of the present disclosure is not limited by the embodiments. Accordingly, it should be understood that the embodiments described above are illustrative in all respects and not restrictive. The scope of protection of the present disclosure shall be construed based on the following claims, and all technical spirits within an equivalent scope thereof shall be construed as being included within the scope of rights of the present disclosure.

What is claimed is:

1. A query processing device comprising:
at least one memory including a plurality of instructions;
a first storage device in which property information for vertices and edges is stored in relational tables;
a second storage device in which a vertex record including connection information of the vertices in a graph and an edge record including connection information of edges in the graph are stored; and
at least one processor electrically connected to the at least one memory and configured to execute the plurality of instructions,
wherein, when the plurality of instructions are executed by the at least one processor, the at least one processor performs a plurality of operations,
the plurality of operations include
an operation of receiving a query for a property graph stored separately in the first storage device and the second storage device;
an operation of calling data required for execution of the query from the first storage device and the second storage device;
an operation of performing an operation on the query using a single integrated operator that performs at least one of traversal, join, and mapping operations depending on data types of a first operand and a second operand based on the called data; and
an operation of outputting a result of executing the query, and
the called data includes operands and operation relationship information between the operands defined by the query.

2. The query processing device of claim 1,
wherein the vertex record includes an ID field, a label field, an output edge pointer field, an input edge pointer field, and a property-tuple pointer field,
the edge record includes an ID field, a label field, a source vertex pointer field, a destination vertex pointer field, a next output edge pointer field, a next input edge pointer field, and a property-tuple pointer field,
the output edge pointer field stores an address of at least one edge output from the vertex,
the input edge pointer field stores an address of at least one edge input to the vertex,
the property-tuple pointer field of the vertex record stores an address of the relational table connected to the vertex record,
the next output edge pointer field stores an address of a next edge output from a source vertex stored in the source vertex pointer field,
the next input edge pointer field stores an address of a next edge input to a destination vertex stored in the destination vertex pointer field, and
the property-tuple pointer field of the edge record stores an address of the relational table connected to the edge record.

3. The query processing device of claim 2,
wherein the output edge pointer field includes one subfield for each label type of edges included in the graph, and
the input edge pointer field includes one subfield for each label type of edges included in the graph.

4. The query processing device of claim 1, wherein the plurality of operations further include an operation of processing update requests corresponding to the first storage device and the second storage device in one transaction.

5. The query processing device of claim 4,
wherein the operation of processing the update requests in one transaction includes:
an operation of receiving a label and a property of a graph element to be inserted into the first storage device and the second storage device;
a first storage device update operation of storing the property of the graph element to be inserted in the relational table of the first storage device; and
a second storage device update operation of storing the label of the graph element to be inserted into a label field of the vertex record or the edge record of the second storage device, and storing the address of the relational table in which the graph element to be inserted is stored in the property-tuple pointer field of the vertex record or edge record.

6. The query processing device of claim 4,
wherein the operation of processing the update requests in one transaction includes
an operation of recording content of the update requests for the first storage device and the second storage device; and
an operation of restoring all changes reflected in the first storage device and the second storage device to original states based on the recorded content of update requests when an error occurs in the update operation of the first storage device or the second storage device.

7. The query processing device of claim 1, wherein the integrated operator selectively performs traversal, join, and mapping operations within a single query processing layer.

8. The query processing device of claim 1,
wherein the operation of performing an operation on the query using the integrated operator includes
an operation of performing a traversal operation on the first operand and the second operand when both the first operand and the second operand are graph elements including at least one of a set of vertices stored in the second storage device and a set of edges stored in the second storage device;
an operation of performing a join operation on the first operand and the second operand when both the first operand and the second operand are relational data stored in the relational table of the first storage device;
an operation of performing a first mapping operation between the graph element of the first operand and the relational database of the second operand when the first operand is the graph element and the second operand is the relational data; and
an operation of performing a second mapping operation between the relational database of the first operand and the graph element of the second operand when the first operand is the relational database and the second operand is the graph element.

9. The query processing device of claim 8,
wherein the plurality of operations further include an operation of generating a query processing plan based on the called data,
the operation of generating the query processing plan includes
an operation of calculating a cost for each possible operation order combination between the operands; and
an operation of selecting an optimal subplan requiring the lowest cost in the possible operation order combinations,
the operation of calculating the cost includes
an operation of calculating a cost of the traversal operation using the integrated operator based on the number of traversal start points, disc I/O cost, CPU operation cost, and buffer cache effect;
an operation of calculating a cost of the join operation using the integrated operator based on a size of a participating table, disc I/O cost, CPU operation cost, and intermediate result size; and
an operation of calculating a cost of the mapping operation using the integrated operator based on a pointer traversal cost, disc I/O cost, and CPU operation cost, and
the operation of calculating the cost of the traversal operation includes weighting disc access and operation costs by reflecting an average connection degree of the vertices when a traversal direction of the traversal operation proceeds from the vertex to the edge.

10. The query processing device of claim 1,
wherein the plurality of operations further include
an operation of extracting at least one graph from the relational table stored in the first storage device; and
an operation of storing data of the extracted graph in the second storage device, the operation of calling the required data includes an operation of calling data related to the at least one graph from the second storage device, and
the operation of performing an operation on the query includes an operation of performing an operation on data related to a plurality of graphs.

11. A method of processing a query in a query processing device including at least one memory including a plurality of instructions, a first storage device in which property information for vertices and edges is stored in relational tables, a second storage device in which a vertex record including connection information of the vertices in a graph and an edge record including connection information of edges in the graph are stored, and at least one processor electrically connected to the at least one memory and configured to execute the plurality of instructions, the method comprising:
an operation of receiving a query for a property graph stored separately in the first storage device and the second storage device;
an operation of calling data required for execution of the query from the first storage device and the second storage device;
an operation of performing an operation on the query using a single integrated operator that performs at least one of traversal, join, and mapping operations depending on data types of a first operand and a second operand based on the called data; and
an operation of outputting a result of executing the query, and
the called data includes operands and operation relationship information between the operands defined by the query.

12. The method of claim 11,
wherein the vertex record includes an ID field, a label field, an output edge pointer field, an input edge pointer field, and a property-tuple pointer field,
the edge record includes an ID field, a label field, a source vertex pointer field, a destination vertex pointer field, a next output edge pointer field, a next input edge pointer field, and a property-tuple pointer field,
the output edge pointer field includes one subfield for each label type of edges included in the graph, and stores an address of at least one edge output from the vertex,
the input edge pointer field includes one subfield for each label type of edges included in the graph, and stores an address of at least one edge input to the vertex,
the property-tuple pointer field of the vertex record stores an address of the relational table connected to the vertex record,
the next output edge pointer field stores an address of a next edge output from a source vertex stored in the source vertex pointer field,
the next input edge pointer field stores an address of a next edge input to a destination vertex stored in the destination vertex pointer field, and
the property-tuple pointer field of the edge record stores an address of the relational table connected to the edge record.

13. The method of claim 11, further comprising an operation of processing update requests corresponding to the first storage device and the second storage device in one transaction.

14. The method of claim 13,
wherein the operation of processing the update requests in one transaction includes:
an operation of receiving a label and a property of a graph element to be inserted into the first storage device and the second storage device;
a first storage device update operation of storing the property of the graph element to be inserted in the relational table of the first storage device; and
a second storage device update operation of storing the label of the graph element to be inserted into a label field of the vertex record or the edge record of the second storage device, and storing the address of the relational table in which the graph element to be inserted is stored in the property-tuple pointer field of the vertex record or edge record.

15. The method of claim 13,
wherein the operation of processing the update requests in one transaction includes
an operation of recording content of the update requests for the first storage device and the second storage device; and
an operation of restoring all changes reflected in the first storage device and the second storage device to original states based on the recorded content of update requests when an error occurs in the update operation of the first storage device or the second storage device.

16. The method of claim 11, wherein the integrated operator selectively performs the traversal, join, and mapping operations within a single query processing layer.

17. The method of claim 11,
wherein the operation of performing an operation on the query using the integrated operator includes
an operation of performing a traversal operation on the first operand and the second operand when both the first operand and the second operand are graph elements including at least one of a set of vertices stored in the second storage device and a set of edges stored in the second storage device;
an operation of performing a join operation on the first operand and the second operand when both the first operand and the second operand are relational data stored in the relational table of the first storage device;
an operation of performing a first mapping operation between the graph element of the first operand and the relational database of the second operand when the first operand is the graph element and the second operand is the relational data; and
an operation of performing a second mapping operation between the relational database of the first operand and the graph element of the second operand when the first operand is the relational database and the second operand is the graph element.

18. The method of claim 17, further comprising:
an operation of generating a query processing plan based on the called data,
wherein the operation of generating the query processing plan includes
an operation of calculating a cost for each possible operation order combination between the operands; and
an operation of selecting an optimal subplan requiring the lowest cost in the possible operation order combinations,
the operation of calculating the cost includes
an operation of calculating a cost of the traversal operation using the integrated operator based on the number of traversal start points, disc I/O cost, CPU operation cost, and buffer cache effect;
an operation of calculating a cost of the join operation using the integrated operator based on a size of a participating table, disc I/O cost, CPU operation cost, and intermediate result size; and
an operation of calculating a cost of the mapping operation using the integrated operator based on a pointer traversal cost, disc I/O cost, and CPU operation cost, and
the operation of calculating the cost of the traversal operation includes weighting disc access and operation costs by reflecting an average connection degree of the vertices when a traversal direction of the traversal operation proceeds from the vertex to the edge.

19. The method of claim 11, further comprising:
an operation of extracting at least one graph from the relational table stored in the first storage device; and
an operation of storing data of the extracted graph in the second storage device,
wherein the operation of calling the required data includes an operation of calling data related to the at least one graph from the second storage device, and
the operation of performing an operation on the query includes an operation of performing an operation on data related to a plurality of graphs.

20. A computer program stored on a computer-readable recording medium to execute the method according to claim 11 in conjunction with hardware.
